(19) United States
(12) Patent Application Publication
(10) Pub. No.: US 2024/0224896 A1
(43) Pub. Date: Jul. 11, 2024

(54) TREE STUMP REMOVAL ATTACHMENT ASSEMBLY

(71) Applicants: Ovide William DesRosiers, Stony Plain (CA); Jean Paul DesRosiers, Legal (CA)

(72) Inventors: Ovide William DesRosiers, Stony Plain (CA); Jean Paul DesRosiers, Legal (CA)

(21) Appl. No.: 18/151,727

(22) Filed: Jan. 9, 2023

(51) Int. Cl. A01G 23/06

(52) U.S. Cl. CPC A01G 23/062

(57) ABSTRACT

Described are various embodiments of a tree stump and root removal attachment assembly for use on a hydraulic work vehicle. In one embodiment, the attachment assembly comprises a tree stump removal device, comprising an elongated single fork portion for piercingly engaging the ground under tree stump and to push at least a portion thereof out of the ground, and a vertically oriented cutting blade positioned at a designated distance from an end of the single fork portion, the cutting blade comprising a concavely shaped sharp cutting edge bounded at two ends thereof by substantially pointed ends. The assembly further comprises a hydraulic ram mechanically coupled to the cutting blade, to move the cutting blade up and down to cut said least a portion of said tree stump; and a mounting plate removably attachable to the arms of the work vehicle for removably securing the tree stump removal device thereto.

### FIELD OF THE DISCLOSURE

The present disclosure relates to the extraction and removal of tree stumps, roots, or large wood debris, and in particular, to tree stump removal attachment assembly.

### BACKGROUND

U.S. Pat. No. 4,908,946 A (Labounty) discloses heavy duty wood cutting shear attachments of a large scale for connection to a boom structure of a hydraulic excavator for cutting tree stumps and the like. The wood cutting shear includes a swingable jaw and a stationary jaw. The swingable jaw has a C-shaped frame with a knife like cutting blade affixed therein. The stationary jaw includes a stump supporting section having a blade receiving slot with a width of approximately the thickness of the cutting blade. Besides slicing through a stump placed between the jaws, the knife like blade may cooperate with the stump supporting section to shear portions of the stump being sliced. Shortcomings include a lack of an elongated straight single fork portion for piercingly engaging the stump, a lack of a vertically oriented cutting blade having a concavely shaped cutting edge bounded by two pointed ends, and a lack of a mounting plate allowing multiple lateral mounting positions.

U.S. Pat. No. 3,814,152 A (Pallari) discloses an device for the combined removal and crushing of tree stumps which is adapted to be attached to the jib of a work machine, said device including a downwardly extending hook for stump removal, rearwardly extending arms for supporting the removed stump, the arms being spaced apart to provide a gap between and a rotatable cutting blade aligned with the gap and arranged to split the supported stump. Shortcomings include a lack of an elongated straight single fork portion for piercingly engaging the stump, a lack of a vertically-oriented cutting blade having a concavely shaped cutting edge bounded by two pointed ends, and a lack of a mounting plate allowing multiple lateral mounting positions.

U.S. Pat. No. 8,146,628 B2 (Tucker) discloses a shear type tree cutter assembly adapted to be mounted on a four wheel field vehicle. The assembly includes an anvil with a concave section for supporting the trunk of a tree. The blade portion has a convex portion that cooperates with the concave section of the anvil to shear the tree. The blade and anvil section also may include a straight portion useful for pruning brush and small limbs. Shortcomings include a lack of an elongated straight single fork portion for piercingly engaging the stump, a lack of a vertically oriented cutting blade having a concavely shaped cutting edge bounded by two pointed ends, and a lack of a mounting plate allowing multiple lateral mounting positions.

U.S. Pat. No. 5,179,985 (Pallari) discloses a stump lifting and crushing device for mounting to an end of a bucket arm of a digging machine. In one example, the device includes stump lifting hooks and a bit pivotally closable with a counter bit for crushing stumps therebetween. The bit has an elongated narrow cutting surface which cooperates with an aligned counter surface provided by the counter bit. The counter surface extends transversely across the width of the cutting surface of the bit. The closing movement of the bits is limited by the cam-like engagement of a following member of the bit with a stop member of the counter bit. Shortcomings include a lack of an elongated straight single fork portion for piercingly engaging the stump, a lack of a vertically oriented cutting blade having a concavely shaped cutting edge bounded by two pointed ends, and a lack of a mounting plate allowing multiple lateral mounting positions.

U.S. Pat. No. 6,564,836 B2 (Cook) discloses an device that lifts, secures, splits and/or crushes tree stumps or other materials, particularly wooden materials and other materials that may be present at an excavation site. The device is characterized in part by a two pivot point design. A first pivot point allows for the pivotable operation of an engaging unit which grabs and lifts the tree stump. The engaging unit further acts as a durable and secure support member for the tree stump during the splitting and crushing process. The second pivot point allows for the pivotable operation of a cutting device which facilitates splitting and crushing of the stumps. Shortcomings include a lack of an elongated straight single fork portion for piercingly engaging the stump, a lack of a vertically oriented cutting blade having a concavely shaped cutting edge bounded by two pointed ends, and a lack of a mounting plate allowing multiple lateral mounting positions.

U.S. Pat. No. 6,308,440 B1 (Mueller) discloses an excavation attachment for a powered loader, e. g., skid steer loader, front end loader, etc. The attachment provides considerably greater leverage for removal of stumps, large imbedded concrete blocks and stones, etc., from the underlying surface. The attachment includes a transverse cylinder or drum with one or more tines extending generally radially therefrom. The attachment is secured to a conventional front end loader, skid steer loader, etc., and the tines inserted beneath the object to be moved. A second embodiment includes one or more hydraulically actuated tines opposed to the fixed tines, for use as a grappler device. Shortcomings include a lack of an elongated straight single fork portion for piercingly engaging the stump, a lack of a vertically oriented cutting blade having a concavely shaped cutting edge bounded by two pointed ends, and a lack of a mounting plate allowing multiple lateral mounting positions.

U.S. Pat. No. 5,901,477 A (Weaver) discloses a tree-removing device designed for mounting on a land vehicle such as a conventional bulldozer or tractor and having a bulldozer-type blade fitted with a power blade for cutting the roots of a tree and a tree jack for levering the tree from the ground after the roots are cut. The power blade is characterized by a frame pivoted to the bulldozer-type blade and a vertically-adjustable blade carrier mounted in the frame and internally fitted with a hydraulically-operated blade which may be extended into the ground from the blade carrier to cut the roots of a tree by operation of the land vehicle. The tree jack includes a jack frame pivoted to the land vehicle bulldozer-type blade and a mast extensibly attached to the jack frame, which jack frame is fitted at one end with a foot for engaging the tree. The mast includes hydraulic cylinders for both engaging the tree and causing the mast to pivot, thereby jacking the tree from the earth by operation of the jack frame foot. Shortcomings include a lack of an elongated straight single fork portion for piercingly engaging the stump, a lack of a vertically oriented cutting blade having a concavely shaped cutting edge bounded by two pointed ends, and a lack of a mounting plate allowing multiple lateral mounting positions.

U.S. Pat. No. 7,520,306 B1 (Berge) discloses a tree and stump remover, suitable for use on skid-steer or similar vehicles. In one example, the remover has a coupling operative with standard bucket mounts. Forward and generally centrally protruding from the coupling is a knife with teeth, serrations, or hooks. In alternative embodiments, the teeth, serrations, or hooks may move relative to each other, or be fixedly mounted. Knife support plates extend the width of the device, and are provided for engagement with the base of a tree. In one preferred embodiment, additional smaller spikes extend adjacent to and spaced from the knife, which further facilitate cutting roots and toppling a tree in a single movement. A process of removing trees and stumps using the preferred device includes cutting the roots extending away from the stump or tree from at least a first side, lifting or toppling the remaining root bundle, and shaking or piercing the root bundle to release dirt retained therein. Shortcomings include a lack of a vertically-oriented cutting blade having a concavely shaped cutting edge bounded by two pointed ends, and a lack of a mounting plate allowing multiple lateral mounting positions.

U.S. Pat. No. 7,938,153 B1 (Gregory, Jr.) discloses a shear attachment for use with different types of motorized vehicles. In some embodiments, the attachment is generally provided with an upper cutting jaw, a lower receiving jaw and a plurality of teeth along the upper surface of the lower jaw to grip an object while it is being cut between the upper and lower jaws. A single actuator may be used to move the cutting jaw between open and closed positions. The shear may be pivoted about a horizontal axis with respect to its mounting bracket to facilitate cutting at different angles. The shear is removably coupled to the vehicle using a universal hitch. The efficient design of the shear makes it durable, inexpensive to manufacture and easy to operate. Shortcomings include a lack of an elongated straight single fork portion for piercingly engaging the stump, a lack of a vertically-oriented cutting blade having a concavely shaped cutting edge bounded by two pointed ends, and a lack of a mounting plate allowing multiple lateral mounting positions.

U.S. Pat. No. 7,610,698 B2 (May) discloses an device for extracting plant species of varying heights and varying diameters adapted to be mounted on a conventional land vehicle includes a frame and an extracting member rigidly attached to and extends outwardly from a bottom edge of the frame. The extracting member includes a first elongated extracting portion having a knife-like free end, a pair of second extracting portions each positioned adjacent a respective edge of the first elongated extracting portion and having a cutting edge formed generally perpendicular to the respective edge of the first elongated extracting portion, and a pair of third extracting portions each connecting an end of the cutting edge of the second extracting portion with a respective end of the bottom edge of the frame. A pair of elongated member are attached to the rear surface of the frame for attaching it to the land vehicle. Shortcomings include a lack of a vertically-oriented cutting blade having a concavely shaped cutting edge bounded by two pointed ends, and a lack of a mounting plate allowing multiple lateral mounting positions.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a tree stump removal attachment assembly that provides improvements over the known art. This includes, for example, an elongated straight single fork portion for piercingly engaging a stump, a vertically oriented cutting blade having a concavely shaped cutting edge bounded by two pointed ends, and a mounting plate allowing multiple lateral mounting positions.

In accordance with a first aspect, there is provided a tree stump removal attachment assembly for use on a hydraulic work vehicle, comprising: a tree stump removal device, comprising: an elongated single fork portion for piercingly engaging the ground under the tree stump and to push at least a portion thereof out of the ground; a vertically-oriented cutting blade positioned at a designated distance from an end of the single fork portion, the cutting blade comprising a concavely-shaped sharp cutting edge bounded at two ends thereof by protruding pointed ends; a hydraulic ram coupled to a hydraulic circuit of the work vehicle and mechanically coupled to the cutting blade, so as to move the cutting blade up and down to grab or cut said at least a portion of said tree stump; and a mounting plate removably attachable to one or more arms of the work vehicle having a vertically-oriented rectangular body comprising a front surface and at least one pair of attachment members for removably securing the tree stump removal device thereto so as to have the tip of the single fork portion extending opposite and perpendicularly to the front surface.

In one embodiment, the hydraulic ram comprises a first end and a second end; and wherein the tree stump removal device further comprises: a L-shaped frame, the L-shaped frame comprising an elongated horizontal portion and an elongated vertical portion, wherein: the horizontal portion has a tapered end defining said single fork portion, and comprises a centrally aligned slot therein located at said designated distance and sized to receive therethrough said cutting blade; the vertical portion having hingedly coupled thereto proximate an upper end thereof the first end of the hydraulic ram; and a blade-receiving member configured to removably receive and secure thereto the cutting blade, the blade-receiving member hingedly coupled to the horizontal portion of the frame at a first location proximate an end of the slot located away from said single fork portion, the blade-receiving member further hingedly coupled to the second end of the hydraulic ram; wherein during operation the hydraulic ram is linearly extended or retracted to move the blade-receiving portion and the cutting blade downwardly or upwardly around an horizontal axis at said first location.

In one embodiment, each attachment member of said at least one pair of attachment members is an elongated member extending away perpendicularly from the front surface of the body of the mounting plate to removably secure, at least in part, the tree stump removal device on the mounting plate.

In one embodiment, the vertical portion of the frame further comprising: a hanger portion located proximate an upper end of the vertical portion on a side facing away from said single fork portion, the hanger portion extending outwardly and downwardly and configured to downwardly engage an upper edge of said mounting plate to hang the L-shaped frame on said front surface; and a locking block on a side facing towards said single fork portion, proximate the bottom of the vertical portion; wherein each attachment member of each pair of said at least one pair of attachment members of the mounting plate are horizontally spaced so as to fittingly receive therebetween the vertical portion of the L-shaped frame, and vertically positioned so as to be located proximate the top of the locking block upon the L-shaped frame being hanged on the mounting plate; and comprise at an end thereof a co-aligned locking hole configured to fittingly receive therethrough a locking bolt.

In one embodiment, the blade-receiving member is hingedly coupled to the horizontal portion of the L-shaped frame via a pair of parallel lower hinge plates extending upwardly from two opposite lateral sides of the horizontal portion; the first end of the hydraulic ram is hingedly coupled to the vertical portion of the L-shaped frame via a pair of parallel upper hinge plates located proximate an upper end thereof and extending from lateral sides of the vertical portion towards said single fork portion; and the second end of the hydraulic ram is hingedly coupled to the blade-receiving member via two parallel ram mounting plates located on opposite lateral sides thereof.

In one embodiment, the attachment assembly further comprises: one or more reinforcement members coupled to the vertical portion and the horizontal portion of the L-shaped frame.

In one embodiment, the reinforcement members are raised walls extending from the lateral sides of the horizontal portion and coupled to each of the lower hinge plates and the base of the vertical portion.

In one embodiment, the attachment assembly further comprises: one or more lower reinforcement members affixed to a bottom surface of the horizontal portion of the L-shaped frame and along a length thereof.

In one embodiment, the attachment assembly further comprises: a gripping nose member coupled to an end of said blade receiving member, the gripping member comprising a downwardly oriented portion having an end comprising a plurality of downwardly-oriented teeth at the end thereof; and a gripping plate affixed on a top surface of the horizontal portion of the L-shaped frame, between said slot and the end of the single fork portion, comprising a plurality of upwardly-oriented teeth; and wherein the gripping nose and the gripping plate are configured to secure at least a portion of the tree stump therebetween upon the blade-receiving member being lowered.

In one embodiment, at least one pair of attachment members is located proximate a lateral edge of the mounting plate surface to allow the single fork portion to be moved proximate a vertical obstacle.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a perspective view illustrating a stump removal attachment assembly installed on a work vehicle, the attachment assembly comprising a stump removal device and mounting plate, in accordance with one embodiment;

FIG. 2A, FIG. 2B, FIG. 2C and FIG. 2D are a perspective, side, bottom and top view, respectively, of the stump removal device of FIG. 1, in accordance with one embodiment;

FIG. 3 is a side deconstructed side view of the stump removal device, in accordance with one embodiment;

FIG. 4A, FIG. 4B and FIG. 4C are a front view, side view and top view, respectively, of the mounting plate of FIG. 1, in accordance with one embodiment; and

FIG. 5A and FIG. 5B are reproductions of FIG. 2A and FIG. 2B, respectively, illustrating different measurements thereof, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The tree stump and root removal attachment assembly described herein provides, in accordance with different embodiments, different examples of a tree stump and root removal device and mounting plate which can be removably secured to the arms of a an hydraulic work vehicle, and used to remove and shear tree stumps, roots or large wood debris.

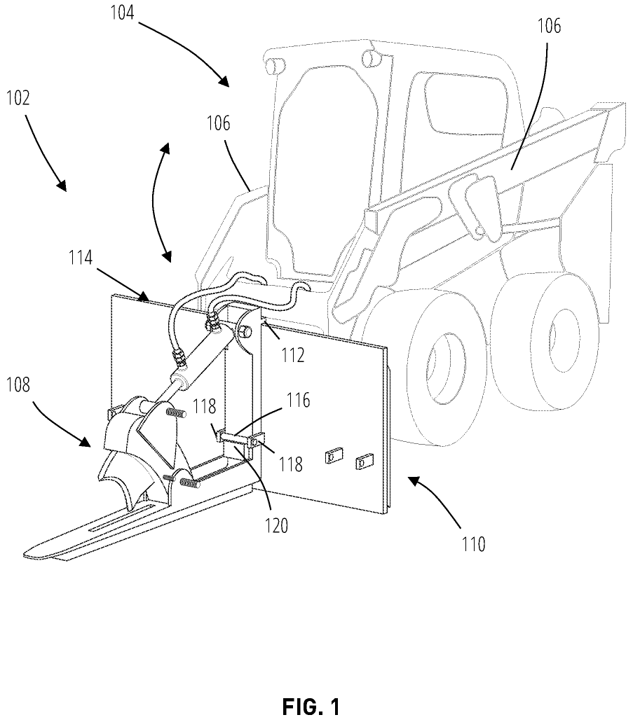

As illustrated in FIG. 1, the tree stump and root removal attachment 102 is configured to be attached to and used with a work vehicle 104. The work vehicle 104 (herein illustrated in FIG. 1 as a skid-steer loader as an example only) typically comprises one or more lift arms 106 at the front thereof that can attach to a wide variety of tools and attachments. Typically, the attachment 102 comprises a tree stump removal device 108 for removing a stump and its roots and a mounting plate 110. The mounting plate 110 is configured to be removably attachable to the arms 106 of the work vehicle 104, and is used, in turn, to removably install the device 108. Once the attachment 102 is installed, an operator of the vehicle 104 can move or tilt the device 108 upwards or downwards by moving or bending the arms 106 so as to remove and lift from the ground, and cut, a tree stump, roots or large wood debris, as will be discussed further below.

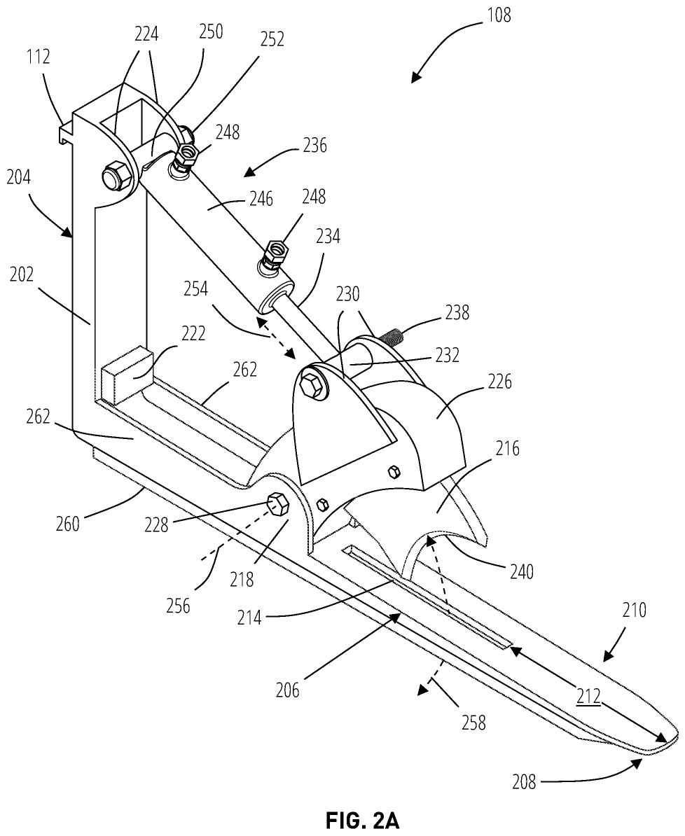

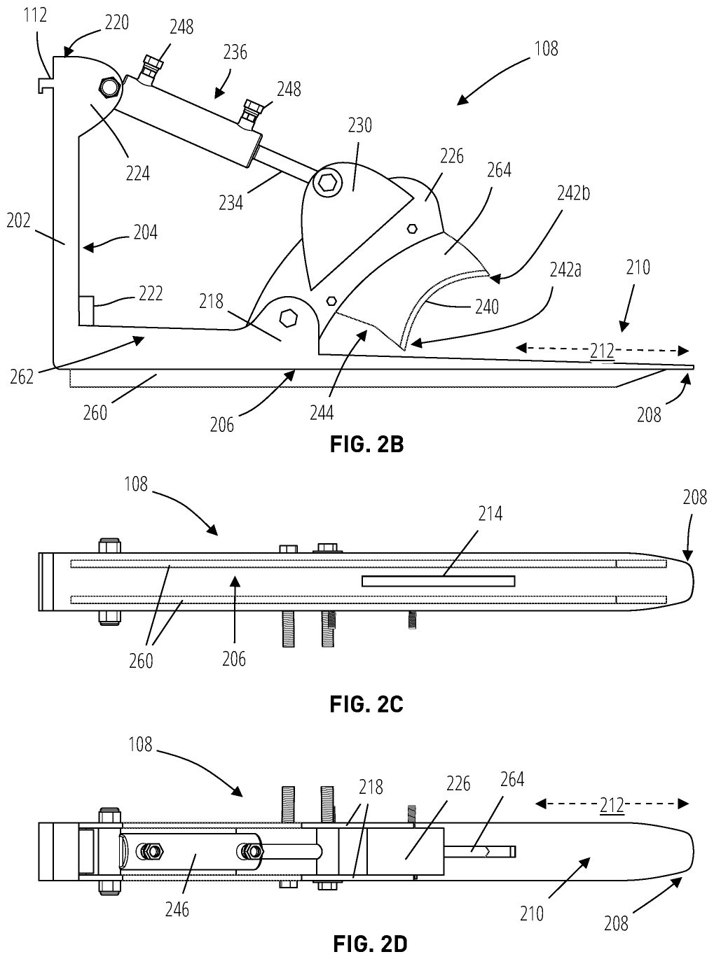

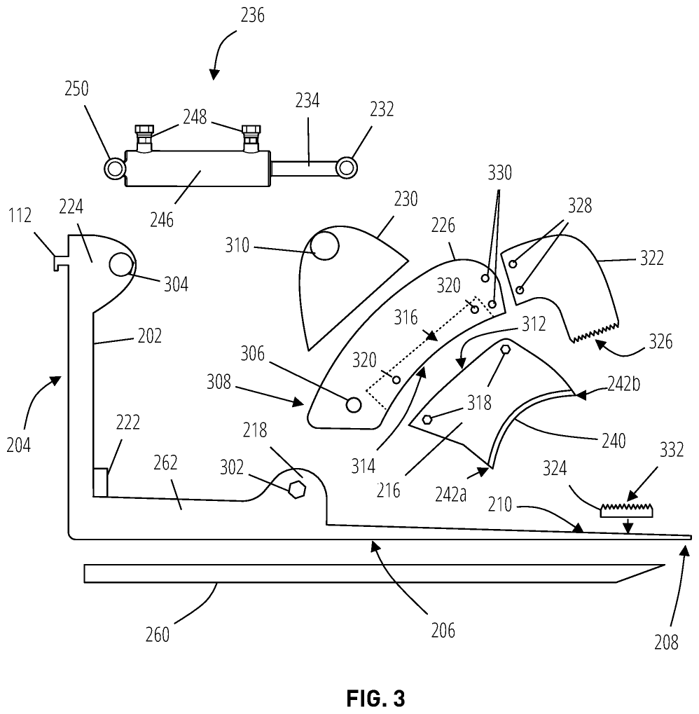

With reference to FIG. 1, FIGS. 2A to 2D, and FIG. 3, an exemplary embodiment of a tree stump and root removal device, herein referred to by the numeral 108, will be discussed. In this example, the device 108 comprises a one-piece L-shaped frame 202 comprising an elongated substantially vertical portion 204 and an elongated substantially horizontal portion 206.

The elongated horizontal portion 206 is substantially flat and straight and tapers at the end 208 thereof to define a single fork portion 210 designed for piercingly engaging the ground under the roots of a tree stump. The single fork portion 212 extends at a designated length 212 in front of a centrally aligned slot 214 on the horizontal portion 206, so as to be able to lift the stump and move it around. The slot 214 is designed to receive therethrough a vertically-oriented cutting blade 216 used for shearing or cutting. In this example, the end or tip 208 of the single fork portion 210 is shown to be slightly rounded but other embodiments may use a more substantially pointed end instead. However, the thickness and strength of the single fork portion 212 should be such that the device can piercingly engage the ground and support thereon a tree stump, roots or large wood debris without being damaged or deformed. The length of the single fork portion 212 may vary but is typically long enough so as to fully secure and lift the stump after engagement. The horizontal portion 206 further comprises extending upwardly from the lateral sides thereof a pair of vertically-aligned lower hinge plates 218, each comprising a respective co-aligned mounting hole 302.

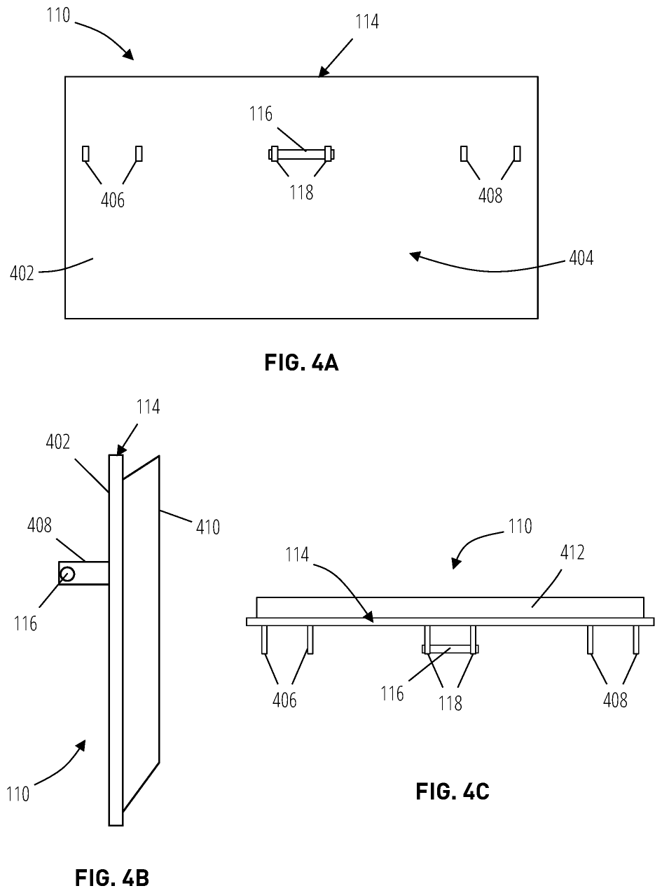

The vertical portion 204 of the frame 202 comprises proximate the upper end 220 thereof, on a rear side facing away from the horizontal portion 206, a bracket-like hanger portion 112 extending away perpendicularly and downwardly. The hanger portion 112 is configured to be downwardly slidingly engageable with an upper edge 114 of a mounting plate 110 (shown in FIG. 1 or in FIGS. 4A-4C). The vertical portion 204 further comprises a locking block 222 protruding from the side thereof facing the horizontal portion 206, at a location proximate the bottom end of the vertical portion 204. The function of the locking block 222, as will be discussed further below, is to lock or retrain the device 108 from moving upwardly while mounted on the mounting plate 110 by abutting against a locking bolt or rod 116 (as shown for example in FIG. 1). The vertical portion 204 further comprises proximate the end 220 thereof, opposite the hanger portion 112, two upper hinge plates 224 extending laterally and parallelly from the sides thereof, and each having a co-aligned ram mounting hole 304.

The blade receiving member 226 is removably hingedly coupled to the two lower hinge plates 218. The blade receiving member 226 comprises a lower mounting hole 306 at a lower end 308 thereof, the lower end 308 being slidingly inserted in-between the two lower hinge plates 218, and hingedly secured thereto by means of a bolt 228 (for example a 1 inch grade 8 bolt or other fastener) inserted in the co-aligned mounting holes 302 (on both lower hinge plates 218) and 306. The blade receiving member 226 further comprises on the upper lateral sides thereof, either extending therefrom or coupled thereto, two parallelly aligned ram mount plates 230. The two ram mount plates 230 comprise co-aligned ram mounting holes 310 (one shown for example in FIG. 3), for hingedly securing thereto the outer end 232 of the piston rod 234 of the hydraulic ram 236, via a fastener such a bolt 238 (or the like).

The vertically-aligned cutting blade 216 is removably affixed to the blade receiving member 226, so as to be detachable to be easily replaced or re-sharpened. In this example, the cutting blade 216 is removably secured to the blade receiving member 226 by engaging the upper portion 312 of the blade in a centrally-aligned and vertically-oriented slot on a side 314 of the blade-receiving portion. The inner cavity 316 formed inside the blade receiving member 226 by the slot is schematically illustrated via the dotted lines 316 of FIG. 3). The cutting blade can be removably secured to the blade-receiving member 226 via two fasteners engaging the co-aligned mounting holes 318 (formed on the cutting blade 216) and 320 (on the blade receiving member 226), shown for example in FIG. 3, upon the blade 216 being engaged in the slot. The slot on the blade-receiving member 216 is typically shaped and sized so as to fittingly receive the upper portion 312 of the cutting blade 216, so that the blade does not move upon being fastened therein.

In some embodiments, the cutting blade 216 comprises a substantially concavely-shaped sharp cutting edge 240 bounded on each side by two protruding pointed ends 242a and 242b (shown for example in FIG. 2B or FIG. 3). The pointed ends 242a and 242b of the cutting blade 216 are configured to piercingly engage the stump or large wooden debris upon the blade being lowered, creating break points along the cutting line defined by the cutting edge 240. As illustrated for example in FIG. 2B, the adjacent edge 244 of the cutting edge 240 may also be slightly concavely shaped, so as to create a slightly triangularly-shaped downward-oriented lower pointed end 242a, which allows it to better piercingly engage the wood material and provide a wedge-like action. The concave shape of the cutting edge 240 and the pointed ends 242a and 242b can also help secure the stump or debris when cutting, or can be used to grab or immobilize the stump or portion thereof between ends 242a and 242b when applying less force than required for cutting (via the hydraulic ram 236). In the latter case, the device 102 can be used to grab and move the stump around via the blade 216. Typically, the cutting blade 216 is made of a strong metal such as tool steel or the like. As mentioned above, the cutting blade 216 further comprises two mounting holes 318 therein to removably affix it to the blade-receiving member 216.

The hydraulic ram 236 is a double-acting hydraulic cylinder comprising a cylindrical body 246 having thereon two ports 248 for connecting the ram 236 to hydraulic lines (as illustrated for example in FIG. 1) connected to a hydraulic circuit, and a piston rod 234. The hydraulic circuit (not shown) is typically located on and controlled from the vehicle 104. Details on how to connect and operate the ram 236 are known in the art and will not be described here. The hydraulic ram 236 further comprises a first mounting member 250 is located at and end of the body 246, and a second mounting member 232 located at the end of the piston rod 234. Both mounting members 250 and 232 are cylindrically-shaped and horizontally-aligned so as to be fittingly and removably mounted between the upper hinge plates 236 and the ram mount plates 230, respectively. Both mounting members 250 and 232 are co-aligned with the mounting holes 310 and 312, respectively, and secured via a fastener such as a bolt or the like therethrough (e.g., bolts 252 and 238 for example). As described and illustrated, the ends 250 and 232 of the hydraulic ram are each free to rotate around the horizontal axis defined by the fasteners. The hydraulic ram 236 can be operated via the hydraulic circuit from the vehicle 104 so as to linearly extend or retract the piston rod 234 (as shown by the dashed arrow 254). When the piston rod 234 of the hydraulic ram 236 is extended or retracted, the blade receiving member 226 is hingedly rotated downwards or upwards, respectively, around hinge axis 256 so as to close or open the cutting blade 216 (as illustrated by the dashed arrow 258).

In some embodiments, to increase the strength of the frame 202 and prevent bending or deformation of the horizontal portion 206, reinforcement gusset plates or brackets may be included. In the illustrated example of FIGS. 2A-2D, and FIG. 3, this includes a pair of elongated reinforcement members 260 welded on the bottom surface 206 of the horizontal portion 206. In addition, a pair of reinforcement members 262 coupled to both the horizontal portion 206 and the vertical portion 204 may also be used. In this example, the reinforcement members 262 are shown as raised vertical wall portions extending from each of the lower hinge plates 218 and the lateral sides of the horizontal portion to the base of the vertical portion 204. However, the skilled person in the art will appreciate that other types of reinforcement members may be used in addition or in replacement of those illustrated herein, without limitation.

In some embodiments, a grapple nose member 322 and grip plate 324 may also be provided on the device 108. As illustrated in FIG. 3, the grapple nose member 322 comprise a downward facing end 326 comprising downwardly oriented teeth or the like. It may be attached to the upper end of the blade-receiving member 226 by co-aligning the mounting holes 328 on the grapple nose member 322 and the mounting holes 330 on the blade-receiving member 226. In other embodiments, the grapple nose member 322 may be one-piece extension of the blade-receiving member 226 and not a separate attachable element. The grip plate 324 may be affixed on the top side of the single fork portion 210 (as illustrated by the arrow), and comprises upwardly oriented teeth 332. The grapple nose member 322 and the grip plate 324 are configured so as to secure or engage therebetween a stump or portion thereof upon the blade-receiving member 226 being moved downwards. This can be used to grab and move around the stump or portion thereof.

FIGS. 4A to 4C show different views of a mounting plate 110, in accordance with one embodiment. In this example, the mounting plate 110 comprises a rectangular body 402 comprising an upper edge 114. In some embodiments, the mounting plate 110 comprises at least one pair of elongated attachment members projecting outwardly and perpendicularly from the front surface 404 of the body 402. In this example, three pairs are provided (e.g., pairs 406, 118 and 408) which are positioned at different locations along the horizontal orientation. In this example, the pair 118 is centrally located while the pairs 406 and 408 are proximate to the lateral edges or sides of the body 402. This provides different lateral mounting locations to mount and secure the device 108 to the mounting plate 110. This may be useful if the tree stump or wood debris is located proximate a wall or vertical barrier or obstacle, in which case the pairs 406 or 408 may allow to move the device 108 closely and parallel to the obstruction while still allowing to operate the vehicle. In addition, body 402 may comprising reinforcement members 410 proximate the sides and 412 proximate the upper edge, for example. On the back side (not shown) of the mounting plate are one or more attachment means for removably attaching the mounting plate 110 to the arms 106 of the vehicle 104. These are well-known in the art and will not be discussed here. Different attachment means for different types of vehicles or arms may be used, as will be appreciated by the skilled person in the art.

Each pair of attachment members 406, 118 or 408 comprise a co-aligned locking hole (for example hole 116 in FIG. 4B) at the distal end thereof, shaped so as to fittingly receive therethrough a locking bolt or rod 116 (for example locking rod 116 in FIG. 1). In addition, in some embodiments the attachment members (e.g., 406, 118 and 408) may be provided as separate elements that are affixed or installed on the front surface 404 on the mounting plate 110, in which case the mounting plate 110 comprises mounting holes (not shown) at the corresponding locations configured to securely receive the members therein.

The skilled person in the art will appreciate that different materials may be used to manufacture the attachment assembly 102 (including each part described above). Typically, these are made of strong and resistant materials that can sustain the forces caused by the removal of tree stumps or roots, for example tool steel or the like.

As illustrated in FIG. 1, in some embodiments, the attachment assembly 102 can be removably mounted on a vehicle 104 as follows:
1) The mounting plate 110 is installed at one or more designated locations on the arms 106 of the vehicle 104 via one or more attachment means known in the art corresponding to the vehicle specifications.
2) The tree stump removal device 108 is removably mounted on the mounting plate 110 by downwardly engaging the hanger portion 112 of the device 108 on the upper edge 114 of the mounting plate 110. The device 108 is positioned at one of the designated mounting locations on the front surface 404 of the mounting plate 110. In the example of FIG. 1, the device 108 is installed centrally, and is slidingly positioned so that the vertical portion 204 of the frame 202 is fittingly located in-between the attachment members 118, so that the rear side of the vertical portion 204 of the L-shaped frame 202 abuts or rests on the front surface 404 of the mounting plate 110. The width of the vertical portion and the distance between the attachment members is selected so that the vertical portion is fittingly surrounded by the members to prevent any lateral movement. The locking block 222 is positioned on the vertical portion 204 of the frame 202 so as to be located just under the locking rod 116 when it is inserted through the members 118, so that its upper surface rests on the bottom side of the locking rod 116. The locking block 120 thus prevents the device 108 from moving or tilting upwards during operation.
3) The hydraulic ram 236 is connected to the vehicle's hydraulic circuit via two connection lines.

As a non-limiting example only, as will be appreciated by the skilled person in the art, to remove a tree stump, roots or large wood debris, the attachment assembly 102 may be used as follows:
1) The operator positions the vehicle 104 in front of the tree stump, roots or similar wood debris, with the end 208 of the single fork portion 210 pointing in a slightly downwards orientation. In some cases, the arms 106 may be raised and tilted downwards so at to have end 208 pointing downwards from a designated elevation and angle.
2) The vehicle and/or the arms of the vehicle are moved forward and/or downwards to piercingly engage the single fork portion 210 into the ground under the roots of the stump.
3) The arms 106 of the vehicle 104 are moved upwards, thus at least partially uprooting the stump. By applying a sufficient force with the blade 264, or by using the grapple nose 322 and grip plates 324, the stump or a portion thereof can be secured and moved (without being cut). In some cases, the arms can be elevated so as to have the end or tip 208 of the single fork portion 210 pointing upwards, to have the engaged stump slidingly move downwards on the single fork portion towards the cutting blade 264 (e.g. “feeding” the blade) via the action of gravity. Once a portion of the stump is in contact with the raised cutting blade 264, the hydraulic ram 236 is activated to move the vertically-aligned cutting blade 264 downwards with a force sufficient to piercingly and cuttingly engage the stump portion via the pointed ends 242a and 242b and the sharp cutting edge 240. The blade can be opened and closed multiple times until the portion of the stump is cut or sheared in two. In some cases, the cutting blade may also be activated at step 2) while “pushing” the single fork portion 210 against the stump with the arms and/or the vehicle.
4) Steps 2) and 3) can be repeated as necessary until the stump has been removed.

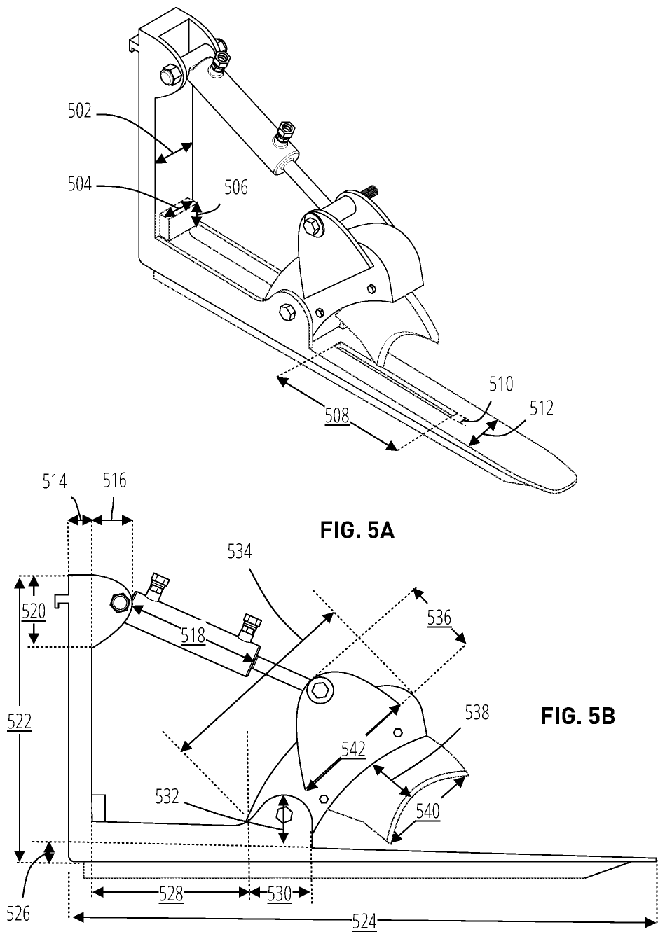

With reference to FIGS. 5A and 5B, table 1 below gives a list of exemplary measurements for different elements of the root removal device 102. The skilled person in the art will understand that these are only given by way of example and that variations may be used as well, without limitation.

TABLE 1

| Reference Number | |
|---|---|
| (FIGS. 5A and 5B) | Measurement |
| 502 | 4″ |
| 504 | 3″ |
| 506 | 2″ |
| 508 | 12 ½″ |
| 510 | ¾″ |
| 512 | 4″ |
| 514 | 1 ¾″ |
| 516 | 3″ |
| 518 | 10 ¼″ |
| 520 | 5 ½″ |
| 522 | 21 ½″ |
| 524 | 44″ |
| 526 | 2″ |
| 528 | 9 ½″ |
| 530 | 6″ |
| 532 | 3 ½″ |
| 534 | 16″ |
| 536 | 6″ |
| 538 | 8″ |
| 540 | 9 ½″ |
| 542 | 9 ½″ |

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure. All structural and functional equivalents to the elements of the above-described preferred embodiments and additional embodiments as regarded by those of ordinary skill in the art are hereby expressly incorporated by reference and are intended to be encompassed by the present claims. Various changes and modifications in form, material, workpiece, and fabrication material detail may be made, without departing from the spirit and scope of the present disclosure, as set forth in the appended claims, and as may be apparent to those of ordinary skill in the art, are also encompassed by the disclosure.

What is claimed is:

1. A tree stump removal attachment assembly for use on a hydraulic work vehicle, comprising:
a tree stump removal device, comprising:
an elongated single fork portion for piercingly engaging the ground under the tree stump and to push at least a portion thereof out of the ground;
a vertically-oriented cutting blade positioned at a designated distance from an end of the single fork portion, the cutting blade comprising a concavely-shaped sharp cutting edge bounded at two ends thereof by protruding pointed ends;
a hydraulic ram coupled to a hydraulic circuit of the work vehicle and mechanically coupled to the cutting blade, so as to move the cutting blade up and down to grab or cut said at least a portion of said tree stump; and
a mounting plate removably attachable to one or more arms of the work vehicle having a vertically-oriented rectangular body comprising a front surface and at least one pair of attachment members for removably securing the tree stump removal device thereto so as to have the tip of the single fork portion extending opposite and perpendicularly to the front surface.

2. The attachment assembly of claim 1, wherein said hydraulic ram comprises a first end and a second end; and wherein
the tree stump removal device further comprises:
a L-shaped frame, the L-shaped frame comprising an elongated horizontal portion and an elongated vertical portion, wherein:
the horizontal portion has a tapered end defining said single fork portion, and comprises a centrally aligned slot therein located at said designated distance and sized to receive therethrough said cutting blade;
the vertical portion having hingedly coupled thereto proximate an upper end thereof the first end of the hydraulic ram; and
a blade-receiving member configured to removably receive and secure thereto the cutting blade, the blade-receiving member hingedly coupled to the horizontal portion of the frame at a first location proximate an end of the slot located away from said single fork portion, the blade-receiving member further hingedly coupled to the second end of the hydraulic ram;
wherein during operation the hydraulic ram is linearly extended or retracted to move the blade-receiving portion and the cutting blade downwardly or upwardly around an horizontal axis at said first location.

3. The attachment assembly of claim 2, wherein each attachment member of said at least one pair of attachment members is an elongated member extending away perpendicularly from the front surface of the body of the mounting plate to removably secure, at least in part, the tree stump removal device on the mounting plate.

4. The attachment assembly of claim 3, the vertical portion of the frame further comprising:
a hanger portion located proximate an upper end of the vertical portion on a side facing away from said single fork portion, the hanger portion extending outwardly and downwardly and configured to downwardly engage an upper edge of said mounting plate to hang the L-shaped frame on said front surface; and
a locking block on a side facing towards said single fork portion, proximate the bottom of the vertical portion;
wherein each attachment member of each pair of said at least one pair of attachment members of the mounting plate are horizontally spaced so as to fittingly receive therebetween the vertical portion of the L-shaped frame, and vertically positioned so as to be located proximate the top of the locking block upon the L-shaped frame being hanged on the mounting plate; and comprise at an end thereof a co-aligned locking hole configured to fittingly receive therethrough a locking bolt.

5. The attachment assembly of claim 2, wherein
said blade-receiving member is hingedly coupled to the horizontal portion of the L-shaped frame via a pair of parallel lower hinge plates extending upwardly from two opposite lateral sides of the horizontal portion;
the first end of the hydraulic ram is hingedly coupled to the vertical portion of the L-shaped frame via a pair of parallel upper hinge plates located proximate an upper end thereof and extending from lateral sides of the vertical portion towards said single fork portion; and
the second end of the hydraulic ram is hingedly coupled to the blade-receiving member via two parallel ram mounting plates located on opposite lateral sides thereof.

6. The attachment assembly of claim 2, further comprising:
one or more reinforcement members coupled to the vertical portion and the horizontal portion of the L-shaped frame.

7. The attachment assembly of claim 6, wherein said reinforcement members are raised walls extending from the lateral sides of the horizontal portion and coupled to each of the lower hinge plates and the base of the vertical portion.

8. The attachment assembly of claim 2, further comprising:
one or more lower reinforcement members affixed to a bottom surface of the horizontal portion of the L-shaped frame and along a length thereof.

9. The attachment assembly of claim 2, further comprising:
a gripping nose member coupled to an end of said blade receiving member, the gripping member comprising a downwardly oriented portion having an end comprising a plurality of downwardly-oriented teeth at the end thereof; and
a gripping plate affixed on a top surface of the horizontal portion of the L-shaped frame, between said slot and the end of the single fork portion, comprising a plurality of upwardly-oriented teeth; and
wherein the gripping nose and the gripping plate are configured to secure at least a portion of the tree stump therebetween upon the blade-receiving member being lowered.

10. The attachment assembly of claim 4, wherein at least one pair of attachment members is located proximate a lateral edge of the mounting plate surface to allow the single fork portion to be moved proximate a vertical obstacle.
